(19) United States
(12) Patent Application Publication
(10) Pub. No.: US 2005/0009658 A1
(43) Pub. Date: Jan. 13, 2005

(54) Method for verifying the manufacturing quality of sliding elements in belts therefor

(76) Inventors: Thomas Fichtinger, Neuravensburg (DE); Albert Dick, Tettnang (DE); Georg Straub, Sipplingen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/495,906

(22) PCT Filed: Nov. 29, 2002
(86) PCT No.: PCT/EP02/13464

(30) Foreign Application Priority Data
Dec. 4, 2001 (DE) 101 59 568.9

(51) Int. Cl. F16G 5/16; F16G 1/21; F16G 1/22

(52) U.S. Cl. 474/242

(57) ABSTRACT

Within the scope of the method for verifying the manufacturing quality of sliding elements (1) of sliding element belts, the height distribution of the sliding element shoulders is determined by a 3D measuring device under real contact conditions of the sliding elements (1).

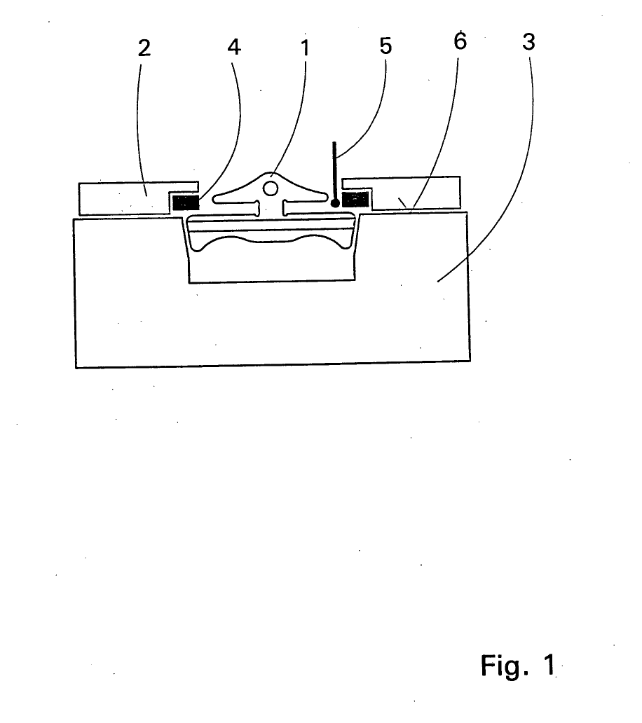

According to the preamble of claim 1, the invention relates to a method for verifying the manufacturing quality of sliding elements in belts made for a continuously variably transmission (CVT).

A continuously variable transmission usually consists, among other elements, of one starting unit, one forward/reverse driving unit, one intermediate shaft, one differential, hydraulic and electronic control devices and one variator.

In the prior art, the variator comprises one primary and one secondary pulley, also called primary and secondary sides, both pulleys being formed by beveled pulleys arranged in pairs. In addition, one variator is provided with one torque-transmitting sliding element which runs between the two pairs of beveled pulleys. In such a transmission, the actual ratio is defined by the running radius of the sliding element which, in turn, is function of the axial position of the beveled pulleys. On one hand, the beveled pulleys are loaded with hydraulic pressure by the oil pump of the transmission for ratio adjustment and, on the other, for ensuring upon the sliding elements the contact pressure needed for torque transmission.

In the prior art, a sliding element, specially for powerful engines, consists of separate sliding elements serving for the real force transmission and of so-called ring sets. Those sliding element belts comprise of a multiplicity of separate metal elements which are assembled and retained upon both sides of the radial plane of the manufactured sliding element belt by a respective elastically deformable ring set.

For a long service life of a sliding element belt, it is important that the manufacturing tolerances of the sliding elements and of the rings be kept very tight and uniform over all parts. The height distribution of the shoulders of the sliding elements is specifically decisive for the contact forces of the rings that run over said shoulders.

The problem on which this invention is based is to outline a method for verifying the manufacturing quality of sliding elements in belts made thereof, which comprises as exact as possible a divergency from the manufacturing tolerances. In addition an apparatus for applying the method is outlined.

For a method this problem is solved by the features of the characteristic part of claim 1. The inventive apparatus for applying the method is the object of claim 10. Other developments and variations result form the sub-claims.

Accordingly, it is proposed to measure the sliding elements by means of a measuring device. The height distribution of the sliding element shoulders is determined with a measuring method, there being preferably used a 3D measuring device.

The sliding element shoulders are advantageously scanned always in the same position of the shoulders. In order to more effectively arrange the execution of the method, the 3D measuring device is clocked in the sliding element thickness distance.

Within the scope of an especially advantageous variation of the inventive method, it is proposed in the operation to clamp the sliding elements with the real contact points of the sliding element sides.

For this purpose is proposed the use of an apparatus comprising one retaining device which makes carrying out the measuring process possible under real contact conditions of the sliding elements.

The invention is explained in detail herebelow with reference to the enclosed FIGURE which shows a preferred embodiment of an inventive apparatus for applying the measuring method.

According to the FIGURE, one part of a sliding element 1 from a sliding element belt is axially clamped in a wedge between two clamping parts 2 of a retaining device 3. The wedge of the retaining device being similar to a wedge of the beveled pulleys of the variator. The holding rails 2 are preferably used as clamping parts. This results in that the elements (sliding elements) 1 of the sliding element belt are positioned with real contact conditions. The sliding elements 1 are positioned here via the sides thereof or the engagement of a dimple in the positioning hole.

It is provided, according to the invention, to compensate for a possible undefined position of the sliding element 1, such as the case of a sliding element that is too narrow, by means of a uniform, elastic contact pressure by an element having elastic properties 4, preferably an elastomer.

After clamping of the sliding elements 1 by means of the retaining device 3, the sliding element shoulders are scanned with a measuring device, advantageously a 3D measuring device with a caliper of the measuring instrument 5, the shoulders are measured always at the same distance upon both shoulders by an adequate adjustment of the measuring device.

The surface of the retaining device 3 serves here as reference plane 6 for a measurement operation. As a result of the measuring process, the height value of the shoulders upon both sides, which can subsequently be further evaluated, is available for each sliding element. In addition, it is provided, according to the invention to clock the measuring device in the sliding element thickness distance in order to make the method more effective.

Reference Numerals

1 sliding element
2 clamping part, holding rail
3 retaining device
4 element with elastic properties
5 caliper of the measuring instrument
6 reference plane

1-13. (CANCELED).

14. A method for verifying manufacturing quality of sliding elements in belts made thereof in which a sliding element (1) is measured by means of a measuring device (5) and height distribution of sliding element shoulders is determined, one or more sliding elements (1) of the belt being clamped for measuring between two clamping parts (2) in one lane of a retaining device (3) in one wedge corresponding to beveled pulleys of a variator, wherein a possible undefined position of the sliding element (1) is compensated by means of a uniform, elastic contact pressure by an element having elastic properties (4).

15. The method according to claim 14, wherein a 3D measuring device with a caliper of the measuring instrument (5) is used.

16. The method according to claim 14, wherein said measuring device (5) is clocked in the sliding element thickness distance.

17. The method according to claim 14, wherein a surface of said retaining device (3) is used as a reference plane (6) for measuring.

18. An apparatus for verifying manufacturing quality of sliding elements in belts comprising one retaining device (3) for sliding elements (1) which is designed so that said sliding elements (1) can be clamped in one wedge under real contact conditions, clamping parts (2) being provided to keep axial said sliding elements (1), wherein said clamping parts (2) are designed as holding rails there being provided on said clamping parts (2) elements having elastic properties (4).

19. The apparatus according to claim 18, wherein said elements with elastic properties (4) are elastomers.
